(19) United States
(12) Patent Application Publication
(10) Pub. No.: US 2003/0097414 A1
(43) Pub. Date: May 22, 2003

(54) Blind postscript function for electronic mail

(76) Inventor: J. David Cabello, Spring, TX (US)

Correspondence Address: THE LAW OFFICES OF COE F. MILES, P.C., 15150 MIDDLEBROOK DRIVE, HOUSTON, TX, 77058, US

(21) Appl. No.: 09/991,457

(22) Filed: Nov. 20, 2001

(51) Int. Cl. G06F 15/16

(52) U.S. Cl. 709/206; 709/238

(57) ABSTRACT

A electronic mail system allows a user to associate a postscript message to a conventional electronic mail message. The postscript message is only transmitted to a recipient identified in an electronic mail message's BCC field. The electronic mail system can allow multiple BCC recipients, each receiving the same, or different, blind-postscript message.

### BACKGROUND

The invention relates generally to electronic mail systems and, more particularly but not by way of limitation, to methods and systems that provide blind-postscript messaging capability.

Many different types of electronic mail systems exist today. Most of these systems provide the ability to designate one or more primary recipients through a “TO” field and one or more secondary recipients through a “CC” or carbon-copy field. It is common that all recipients designated through the use of TO and CC fields are identified to all other recipients. That is, if person1@place1.com is designated as a TO recipient and person2©place2.org is designated as a CC recipient, both person1 and person2 will be able to determine that the other was also sent the electronic mail message.

To provide some privacy, many electronic mail systems allow a composer (i.e., that person generating an electronic mail message) to designate one or more non-disclosed recipients through a “BCC” or blind carbon-copy field. Extending the above example: if person1@place1.com is designated as a TO recipient, person2©place2.org is designated as a CC recipient and person3©place3.net is designated as a BCC recipient, person3 will receive a copy of the associated electronic mail message but will not be displayed in the message header of the TO and CC designated recipients. Accordingly, the BCC function may be used to route a message to a third party without alerting other recipients that this is being done.

While the privacy afforded by the BCC function is often useful, it is limited. For example, there is currently no means to associate a message with a BCC recipient so that only the designated BCC recipient receives the message. Thus, it would be beneficial to provide electronic messaging capability that supports the generation of private messages to BCC designated recipients.

### SUMMARY

In one embodiment of the invention a method to provide blind-postscript messaging includes generating a first message, identifying a primary recipient of the first message, identifying a secondary recipient of the first message, associating a second message with the identified secondary recipient and sending only the first message to the primary recipient and the first and second messages to the secondary recipient. In another embodiment, the act of sending also includes withholding the identity of the secondary recipient from the primary recipient.

In another embodiment of the invention, an electronic mail system includes a display unit, a network means for operatively coupling the electronic mail system to a digital network and a computer unit operatively coupled to the display unit, the computer unit including a processor, a network means and a storage device, the storage device having stored thereon instructions for providing blind-postscript messaging capability.

In some embodiments of a blind-postscript messaging method and system, a user may associate a first blind-postscript message to one or more blind-postscript recipients, and a second (or no) blind-postscript message to another one or more blind-postscript recipients. In general, recipients of blind-postscript messages are not identified to the primary recipients of the associated electronic mail message.

### BRIEF DESCRIPTION OF THE DRAWINGS

FIG. 1 shows an electronic mail message composition window in accordance with one embodiment of the invention.

FIG. 2 shows a blind-postscript message composition window in accordance with one embodiment of the invention.

FIG. 3 shows a blind-postscript recipient selection window in accordance with one embodiment of the invention.

FIG. 4 shows a blind-postscript recipient selection window in accordance with another embodiment of the invention.

FIG. 5 shows a blind-postscript message management window in accordance with one embodiment of the invention.

FIG. 6 shows a blind-postscript recipient edit window in accordance with one embodiment of the invention.

FIG. 7 shows, in flow-chart form, a blind-postscript messaging technique in accordance with one embodiment of the invention.

FIG. 8 shows, in block diagram form, a computer system in accordance with one embodiment of the invention.

### DETAILED DESCRIPTION

The invention relates generally to electronic mail systems and, more particularly but not by way of limitation, to methods and devices for providing a blind-postscript messaging capability in electronic mail systems. The following embodiments of the invention, described in terms of a Microsoft© Windows-like graphical user interface, are illustrative only and are not to be considered limiting in any respect.

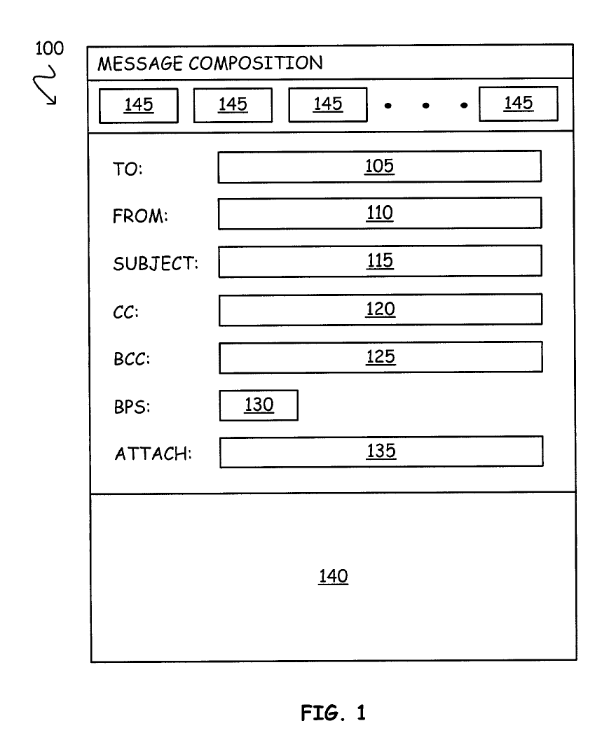

Referring to FIG. 1, electronic mail Message Composition window 100 in accordance with one embodiment of the invention includes: TO field 105, FROM field 110, SUBJECT field 115, CC field 120, BCC field 125, BPS button 130, ATTACH field 135, primary message field 140 and support buttons 145. The TO 105, FROM 110, SUBJECT 115, CC 120, BCC 125, ATTACH 135 and primary message 140 fields function as in conventional electronic mail systems. In addition, support buttons 145 typically provide “Send,” “Cancel,” “Forward,” “Attach,” “Spell Check,” “Print,” “Text Formatting” and “Address Book” functionality, although not all electronic mail systems provide all of these functions while some provide additional functions.

In one embodiment of the invention, a secondary message (hereafter, the “blind-postscript” message) may be associated with those electronic mail addresses identified in BCC field 125, wherein the blind-postscript message is sent to the identified BCC field recipients and not to those recipients identified in the TO and CC fields. In another embodiment of the invention, a blind-postscript message may be selectively associated with one or more electronic mail addresses identified in BCC field 125, wherein the blind-postscript message is sent only to the selected BCC recipients and not to those recipients identified in the TO and CC fields. In still another embodiment of the invention, each designated BCC recipient may have a unique blind-postscript message associated with it, the blind-postscript messages being sent only to the associated BCC recipient and not to other BCC recipients or to the identified TO and CC field recipients. A blind-postscript message may be associated with the primary electronic mail message in any manner desired. For example, the blind-postscript message may be prepended, appended or attached as a separate file to the primary electronic mail message.

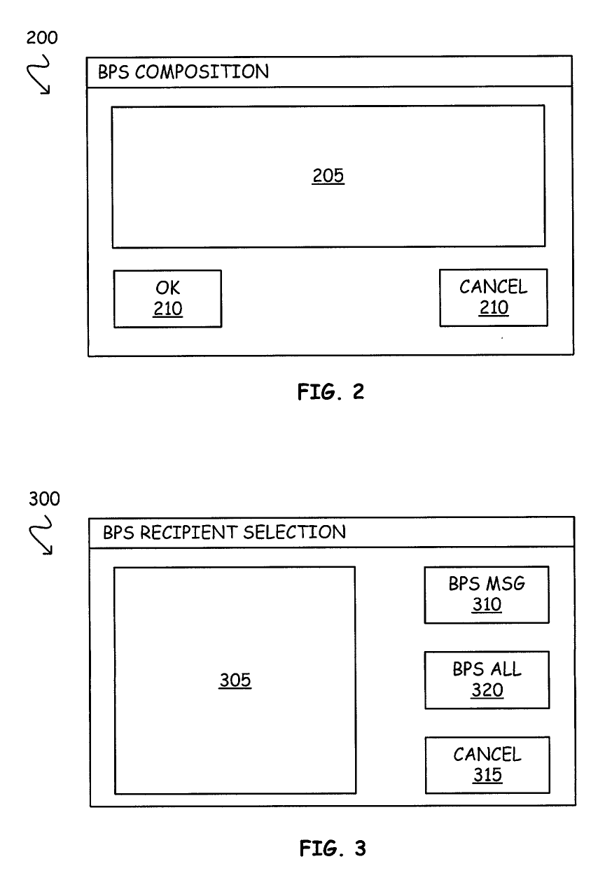

Referring to FIG. 2, in one embodiment of the invention when a user activates BPS button 130, BPS Composition window 200 is presented. The user may then enter a blind-postscript message into field 205 and complete the process by activating OK button 210 or may cancel the blind-postscript operation by activating CANCEL button 215. Alternatively, a BCC recipient may be identified through use of an email application's “address book” function. One of ordinary skill in the art will recognize that additional functionality may be added to BPS Composition window 200. For example, text formatting and spell check capabilities may be provided through additional buttons or as menu items (menus not shown in FIG. 2).

Referring to FIG. 3, in another embodiment of the invention when a user activates BPS button 130, BPS Recipient Selection window 300 is presented. BPS Recipient Selection window 300 may be used when fewer than all identified BCC recipients may be designated to receive a blind-postscript message. In this embodiment, a user may select one or more BCC recipients from BCC list 305 (list 305 can include all BCC recipients identified in BCC field 125). Once selected, the user may transition to a blind-postscript composition window (for example, BPS Composition window 200) by activating BPS MSG button 310 or may cancel the operation by activating CANCEL button 315. In one embodiment, when the user has completed composing their blind-postscript message (via a blind-postscript composition window) they are returned to primary Message Composition window 100. As a user convenience, activation of BPS ALL button 320 may act to select all entries in BCC list 305 and transition to a blind-postscript composition window. Entries in BCC list 305 may be selected in any manner desired. For example, a single mouse-click on an entry may select that entry and a “control-mouse-click” may select a second entry, and so on.

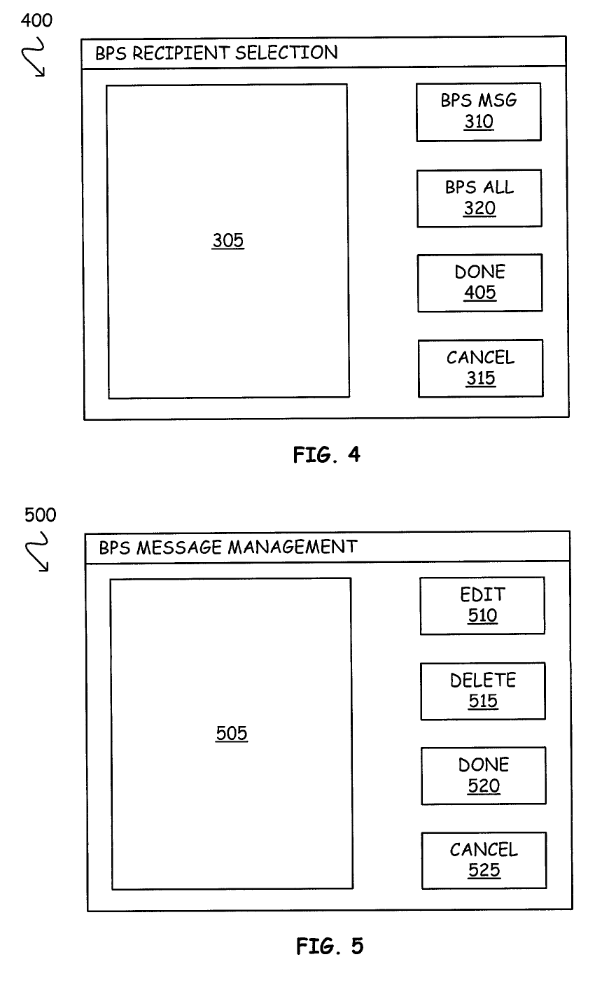

Referring to FIG. 4, in yet another embodiment of the invention, functionality in accordance with FIG. 3 may be augmented to allow the creation of individual blind-postscript messages through BPS Recipient Selection window 400. Operation in accordance with FIG. 4 is similar to that outlined above for FIG. 3. However, after a user completes composing a blind-postscript message to one (or more) selected BCC recipients through a blind-postscript composition window (for example, BPS Composition window 200), the user may be returned to BPS Recipient Selection window 400. Here, the user may select another one or more BCC recipients for another blind-postscript message (repeating the acts described above) or may activate DONE button 405 to indicate they are through creating blind-postscript messages. In addition, the user may cancel any blind-postscript messages generated during the current invocation of BPS Recipient Selection window 400 by activating CANCEL button 315.

Referring now to FIG. 5, BPS Message Management window 500 may be used to assist a user manage those blind-postscript messages associated with a primary electronic mail message. Blind-postscript message list 505 can identify all blind-postscript messages associated with the current primary electronic mail message. The user may select one or more message list entries (see discussion above) and edit the message by activating EDIT button 510 or delete the selected message(s) by activating DELETE button 515. When through, the user may activate DONE button 520 to invoke the changes or may activate CANCEL button 525 to cancel any edits or deletions made during the current invocation of BPS Message Management window 500.

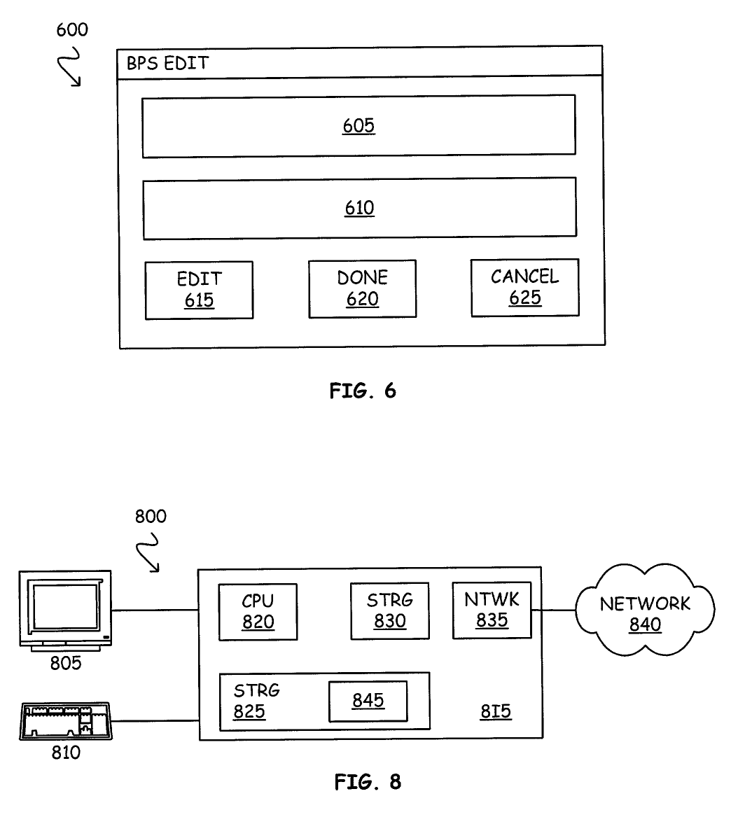

Additional functionality, such as a Select All button, may be provided to BPS Message Management window 500. Further, a means to identify the recipient(s) associated with a listed blind-postscript message may be provided. For example, when a user places their mouse over a blind-postscript message list entry, a pop-up message may identify the BCC recipients designated to receive that message. In another embodiment, shown in FIG. 6, a user may single (or double) click a blind-postscript message list entry to generate BPS Edit window 600. As shown, BPS Edit window 600 may include an editable list (field 605) of recipients associated with the blind-postscript message identified in field 610. From window 600, the user may edit the message's recipient list by activating EDIT button 615, indicate they have completed their editing by activating DONE button 620, or may cancel the operation without invoking any changes made during the current invocation of BPS Edit window 600 by activating CANCEL button 625.

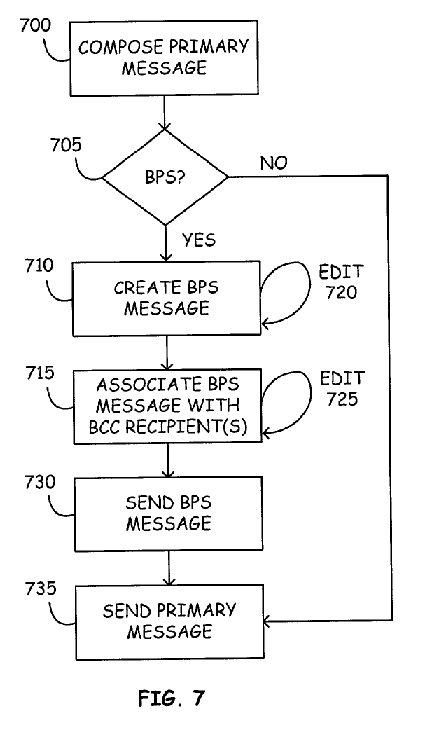

One method to provide blind-postscript messaging capability in accordance with the invention is shown if FIG. 7. A user begins by composing a primary message (block 700), where the primary message is targeted to those recipients designated in the message's TO and CC fields (see FIG. 1, for example). If the user wants to send a private message to one or more BCC designated recipients (the “yes” prong of diamond 705), they compose the message or messages (block 710) and associate it with one or more designated BCC recipients (block 715). As discussed above, some embodiments of the invention provide that the same blind-postscript message be sent (associated with) all designated BCC recipients while other embodiments allow different designated BCC recipients to receive different (or no) blind-postscript message. In addition, edit loops provide a means to edit either the blind-postscript message (edit loop 720) or the message's recipients (edit loop 730). Edit loops 725 and 730 may be implemented, for example, as illustrated in FIGS. 3 through 6. Once both the primary and blind-postscript messages are composed, the blind-postscript message and the primary message is sent to the designated BCC recipients (block 730) and the primary message is sent to the designated TO and CC recipients (block 735). It is noted, BCC recipients are not identified to TO and CC designated recipients. In addition, one BCC recipient need not be identified to another BCC recipient. As describe above, when the blind-postscript message is sent (block 730) it may be prepended, appended or attached as a separate file to the primary message.

If the user does not want to send a private message to one or more BCC designated recipients (the “no” prong of diamond 705), the primary message is sent to the designated primary recipients (block 735) as in conventional electronic mail systems.

Referring now to FIG. 8, computer system 800 in accordance with one embodiment of the invention includes display unit 805, keyboard 810 and computer unit 815. Computer unit 815, in turn, includes processor 820, long-term storage 825, volatile storage 830 and network adapter 835. Network adapter 835 allows computer system 800 to communicate with other computer systems via network 840. By way of example, network adapter 835 could be a modem or a Ethernet connectivity device and network 840 could be the Internet or a private intranet. Program code 845 comprises computer-readable instructions that, when executed by processor 820, provides some or all of the functionality described herein. Program code 845 is conventionally stored in long-term storage 825 and, when invoked by the user (or the user's electronic mail application), temporarily loads into volatile storage 830 from which processor 820 executes it. Processor 820 may be a single computer processor, a plurality of computer processors coupled by a communications link, or a custom designed state machine. Long-term storage 825 may be any storage device suitable for tangibly embodying program instructions such as all forms of non-volatile memory including, but not limited to: semiconductor memory devices such as EPROM (Electrically Programmable Read Only Memory), EEPROM (Electrically Erasable Programmable Read Only Memory), and flash devices; magnetic disks (fixed, floppy, and removable); other magnetic media such as tape; and optical media such as CD-ROM disks. Volatile storage 830 may be any memory including, for example, DRAM (Dynamic Random Access Memory) and SRAM (Static Random Access Memory).

One of ordinary skill in the art will recognize that the operational details described above in terms of FIGS. 1 through 8 may be modified without departing from the scope of the invention. For example, acts in accordance with FIG. 7 may be performed in any practical order so long as blind-postscript messages sent to BCC designated recipients are not also sent to designated TO and CC recipients. In addition, BPS button 130 may be disabled (or not presented to the user at all), until at least one BCC recipient is designated. Additionally, visual cues to indicate that different BCC recipients are associated with different blind-postscript messages may be used. To illustrate the latter, BCC recipients associated with a first blind-postscript message may be displayed in a first color and BCC recipients associated with a second (or no) blind-postscript message may be displayed in a second color. Still further, blind-postscript messaging capability in accordance with the invention may be implemented as program code (e.g., code 845) that is integral to an electronic mail application or it may be implemented as an add-in (also referred to as a “plug-in”) code module that dynamically modifies the operation of an electronic mail application. Yet further, the functionality described in terms of FIGS. 1 through 6 may be provided through menus and not as buttons and/or combined (or separated) to provide a blind-postscript messaging system using fewer (or more) user-interface windows.

While the invention has been disclosed with respect to a limited number of embodiments, numerous additional modifications and variations will be appreciated by those skilled in the art. It is intended, therefore, that the following claims cover all such modifications and variations that may fall within the true sprit and scope of the invention.

What is claimed is:

1. An electronic mail method, comprising:
generating a first message;
identifying a primary recipient of the first message;
identifying a secondary recipient of the first message;
associating a second message with the identified secondary recipient; and
sending only the first message to the primary recipient and the first and second messages to the secondary recipient.

2. The method of claim 1, wherein the act of sending further comprises withholding the identity of the secondary recipient from the primary recipient.

3. The method of claim 1, wherein the act of identifying a primary recipient comprises designating one or more recipients in an electronic mail message TO field.

4. The method of claim 3, wherein the act of identifying a primary recipient further comprises designating one or more recipients in the electronic mail message CC field.

5. The method of claim 1, wherein the act of identifying a secondary recipient comprises designating one or more recipients in an electronic mail message BCC field.

6. The method of claim 1, wherein the act of identifying a primary recipient comprises identifying a plurality of primary recipients, wherein each of said plurality of primary recipients are designated to receive only the first message and the act of sending comprises withholding the identity of the secondary recipient from each of the plurality of primary recipients.

7. The method of claim 1, wherein the act of identifying a secondary recipient comprises identifying a plurality of secondary recipients, wherein each of said plurality of secondary recipients are designated to receive the first message and the second message, and the act of sending comprises withholding the identity of each of the plurality of secondary recipients from the primary recipient.

8. The method of claim 7, further comprising withholding, from each of said plurality of secondary recipients, the identity of the other plurality of secondary recipients.

9. The method of claim 1, wherein a act of identifying a secondary recipient comprises identifying a first secondary recipient and a second secondary recipient.

10. The method of claim 9, wherein the act of associating a second message with the identified secondary recipient comprises:
associating a first second message with the first secondary recipient and a second second message with the second secondary recipient, wherein the first second message and the second second message are different.

11. The method of claim 1, wherein the act of associating a second message comprises associating a file selected from the group consisting of a text file, an application document file, an image file and an executable file.

12. A program storage device, readable by a programmable control device, comprising instructions stored on the program storage device for causing the programmable control device to:
generate a first message;
identify a primary recipient of the first message;
identify a secondary recipient of the first message;
associate a second message with the identified secondary recipient; and
send only the first message to the primary recipient and the first and second messages to the secondary recipient.

13. The program storage device of claim 12, wherein the instructions to send further comprise instructions to withhold the identity of the secondary recipient from the primary recipient.

14. The program storage device of claim 12, wherein the instructions to identify a primary recipient comprise instructions to allow a user to:
designate one or more recipients in an electronic mail message TO field; and
designate one or more recipients in the electronic mail message CC field.

15. The program storage device of claim 12, wherein the instructions to identify a secondary recipient comprise instructions to allow a user to designate one or more recipients in an electronic mail message BCC field.

16. The program storage device of claim 12, wherein the instructions to identify a primary recipient comprise instructions to identify one or more primary recipients and the instructions to identify a secondary recipient comprise instructions to identify one or more secondary recipients.

17. The program storage device of claim 16, wherein the instructions to send further comprise instructions to withhold the identity of the one or more secondary recipients from the one or more primary recipients.

18. The program storage device of claim 17, wherein the instructions to send further comprise instructions to withhold, from each of said plurality of secondary recipients, the identity of the other one or more secondary recipients.

19. The program storage device of claim 12, wherein the instructions to identify a secondary recipient comprise instructions to identify a first secondary recipient and a second secondary recipient.

20. The program storage device of claim 19 wherein the instructions to associate a second message comprise instructions to:
associate a first second message with the first secondary recipient; and
associate a second second message with the second secondary recipient, wherein the first second message and the second second message are different.

21. The program storage device of claim 12, wherein the instructions to associate a second message comprise instructions to associate a file selected from the group consisting of a text file, an application document file, an image file and an executable file.

22. An electronic mail system, comprising:
a display unit; and
a computer unit operatively coupled to the display unit, the computer unit including a processor, a network means and a storage device, the storage device having stored thereon instructions for causing the processor to provide an electronic mail capability to a user through the display and the network means, said electronic mail capability including the capability to
generate a first message,
identify a primary recipient of the first message,
identify a secondary recipient of the first message,
associate a second message with the identified secondary recipient, and
send, by the network means, only the first message to the primary recipient and the first and second messages to the secondary recipient.

23. The electronic mail system of claim 12, wherein the electronic mail capability further comprises the capability to withhold the identity of the secondary recipient from the primary recipient.

24. The electronic mail system of claim 22, wherein the electronic mail capability further comprises the capability to identify a first secondary recipient and a second secondary recipient.

25. The electronic mail system of claim 24, wherein the electronic mail capability further comprises the capability to:
associate a first second message with the first secondary recipient; and
associate a second second message with the second secondary recipient, wherein the first second message and the second second message are different.

26. The electronic mail system of claim 22, wherein the electronic mail capability to associate a second message comprises the capability to associate a file selected from the group consisting of a text file, an application document file, an image file and an executable file.
